(19) United States
(12) Patent Application Publication
(10) Pub. No.: US 2021/0197238 A1
(43) Pub. Date: Jul. 1, 2021

(54) SYSTEMS AND METHODS OF MAINTAINING PIPING IN PLUMBING SYSTEMS

(71) Applicant: Professional Extraction Technologies, Inc., Sarasota, FL (US)

(72) Inventor: Daniel E. Grenier, Sarasota, FL (US)

(21) Appl. No.: 17/137,539

(22) Filed: Dec. 30, 2020

Related U.S. Application Data
(60) Provisional application No. 62/955,004, filed on Dec. 30, 2019.

(51) Int. Cl. B08B 9/035; B08B 9/032; B08B 5/04

(52) U.S. Cl. CPC B08B 9/035; B08B 2209/032; B08B 5/04; B08B 9/0321

(57) ABSTRACT

Disclosed is a method of maintaining fluid flow through a plumbing system, comprising sealing an opening of all but one of the plurality of plumbing fixtures to result in a first unsealed plumbing fixture; connecting a vacuum assembly to an opening of the plumbing system below the horizontal pipe line by connecting a first end of a vacuum conduit to a vacuum source and a second end of the vacuum conduit to the opening of the plumbing system; connecting a pump assembly to the unsealed plumbing fixture by connecting a first end of a fluid conduit to a tank and a second end of the fluid conduit to an opening of the first unsealed plumbing fixture; activating the vacuum source; and introducing a volume of fluid from the pump assembly through the fluid conduit into the opening of the unsealed plumbing fixture. Also disclosed are systems for maintaining fluid flow.

### CROSS-REFERENCE TO RELATED APPLICATION

This application claims priority to U.S. Provisional Application No. 62/955,004, filed on Dec. 30, 2019, and entitled “Systems and Methods of Maintaining Piping in Plumbing Systems.”

### FIELD OF THE INVENTION

The present invention relates to systems and methods for maintaining piping in plumbing systems, and more particularly relates to maintaining piping in sovent plumbing systems.

### BACKGROUND

Plumbing systems often experience numerous drainage problems, such as clogged drains and piping. Piping in plumbing systems is typically not cleaned until a problem has occurred, i.e., a substantial or a complete blockage. A substantial or complete blockage in the piping causes significant drainage issues that could otherwise be prevented by routine maintenance of the plumbing system. In conventional maintenance systems, solid media may be used in an attempt to clean and maintain operability of the plumbing system. However, the introduction of solid media into the plumbing system is less than ideal because it may contribute to additional problems. Solid media is a foreign object that plumbing systems are not designed to handle. The media can become lodged in the nooks and crannies of a Sovent system with no way to remove it without opening the walls or ceilings of the building to access and remove the pipes and fittings of the plumbing system. In particular, media may become lodged in the slot vent of the aerator fitting and/or the pressure relief vent line of the de-aerator system. Media lodged in the plumbing system may cause the system to fail at a faster rate since it may alter proper air flow in the plumbing system and thus the way the system was engineered to work. Further, once media is introduced into a plumbing system there is no way to confirm that all of the media has been removed from the plumbing system.

### SUMMARY

Disclosed herein is a method of maintaining fluid flow through a plumbing system for a multi-floor building comprising a substantially vertical pipe line having a base and a top and extending upwardly within the building and open to atmosphere at the top, at least one aerator connected to the vertical pipe line, at least one horizontal pipe line connected at a first end to the vertical pipe line and connected to a plurality of plumbing fixtures or to one of the aerators, and at least one de-aerator positioned at the base of the vertical line. The method comprises sealing an opening of all but one of the plurality of plumbing fixtures to result in a first unsealed plumbing fixture; connecting a vacuum assembly to an opening of the plumbing system below the horizontal pipe line by connecting a first end of a vacuum conduit to a vacuum source and a second end of the vacuum conduit to the opening of the plumbing system; connecting a pump assembly to the unsealed plumbing fixture by connecting a first end of a fluid conduit to a tank and a second end of the fluid conduit to an opening of the first unsealed plumbing fixture; activating the vacuum source to apply a vacuum suction to the plumbing system; and introducing a volume of fluid from the pump assembly through the fluid conduit into the opening of the unsealed plumbing fixture; wherein the activated vacuum source and the introduced volume of fluid achieve a flow rate that is greater than a gravity-fed pipe flow rate of the plumbing system.

Also disclosed herein is a system for maintaining fluid flow through a plumbing system. The system for maintaining comprises a tank, the tank structured and arranged to contain a volume of fluid therein; and a fluid conduit having first and second ends, the fluid conduit structured and arranged to be fluidically connected at the first end to the tank and at the second end to a first plumbing fixture of the plumbing system; and a vacuum assembly comprising a vacuum source and a vacuum conduit, the vacuum conduit structured and arranged to be sealingly connected to a second opening of the plumbing system, wherein the vacuum assembly is configured to extract the fluid from the plumbing system; and wherein, in use, an activated vacuum source and an introduced volume of fluid achieve a flow rate that is greater than a gravity-fed pipe flow rate of the plumbing system.

### BRIEF DESCRIPTION OF THE FIGURES

FIG. 1 is a schematic of a single stack Sovent system in accordance with the present invention.

FIG. 2 is the flow diagram illustrating a method of maintaining a plumbing system in accordance with the present invention.

### DESCRIPTION

Systems and methods for maintaining fluid flow through piping in plumbing systems are provided. As used herein, the terms “maintaining” or “maintenance” refer to a set of components or a series of steps using such components to retain a plumbing system in, or restore a plumbing system to, a state in which flow rate of at least one of the lines comprising the plumbing system is at least 50% of the maximum flow capacity of such line, such as at least 60%, such as at least 70%, such as at least 80%, such as at least 90%, such as at least 95%, such as 100%. The systems and methods of the present invention may be used on plumbing systems in which neither a vertical pipe line nor the horizontal pipe lines connected to the vertical pipe line are completely blocked. Maintenance may be performed periodically, such as on a yearly or multi-year basis, e.g., once every 3-5 years.

Disclosed herein is a method of maintaining fluid flow through a plumbing system for a multi-floor building comprising a substantially vertical pipe line having a base and a top and extending upwardly within the building and open to atmosphere at the top, at least one aerator connected to the vertical pipe line, at least one horizontal pipe line connected at a first end to the vertical pipe line and connected to a plurality of plumbing fixtures or to one of the aerators, and at least one de-aerator positioned at the base of the vertical line. The method comprises sealing an opening of all but one of the plurality of plumbing fixtures to result in a first unsealed plumbing fixture; connecting a vacuum assembly to an opening of the plumbing system below the horizontal pipe line by connecting a first end of a vacuum conduit to a vacuum source and a second end of the vacuum conduit to the opening of the plumbing system; connecting a pump assembly to the unsealed plumbing fixture by connecting a first end of a fluid conduit to a tank and a second end of the fluid conduit to an opening of the first unsealed plumbing fixture; activating the vacuum source to apply a vacuum suction to the plumbing system; and introducing a volume of fluid from the pump assembly through the fluid conduit into the opening of the unsealed plumbing fixture; wherein the activated vacuum source and the introduced volume of fluid achieve a flow rate that is greater than a gravity-fed pipe flow rate of the plumbing system. As used herein, “gravity-fed pipe flow rate” refers to the maximum water velocity and discharge rate that can be achieved through the pipes of the plumbing system based on gravitational force.

Also disclosed herein is a system for maintaining fluid flow through a plumbing system. The system for maintaining comprises a tank, the tank structured and arranged to contain a volume of fluid therein; and a fluid conduit having first and second ends, the fluid conduit structured and arranged to be fluidically connected at the first end to the tank and at the second end to a first plumbing fixture of the plumbing system; and a vacuum assembly comprising a vacuum source and a vacuum conduit, the vacuum conduit structured and arranged to be sealingly connected to a second opening of the plumbing system, wherein the vacuum assembly is configured to extract the fluid from the plumbing system; and wherein, in use, an activated vacuum source and an introduced volume of fluid achieve a flow rate that is greater than a gravity-fed pipe flow rate of the plumbing system.

The system for maintaining a plumbing system of the present invention comprises a pump assembly. The pump assembly may comprise a tank structured and arranged to contain a volume of fluid therein and a fluid conduit structured and arranged to be fluidically connected to a first plumbing fixture of the plumbing system. The pump assembly may be configured to pump a volume of fluid into the first plumbing fixture. The system may further comprise a vacuum assembly comprising a vacuum source and a vacuum conduit structured and arranged to be sealingly connected to a second opening of the plumbing system. The vacuum assembly may be configured to extract the fluid from the plumbing system.

The plumbing maintenance systems of the present invention may be utilized to aid in keeping the piping of plumbing systems clean and substantially free from blockages. The plumbing maintenance systems of the present invention are provided with features to help prevent significant drainage issues in plumbing systems. The plumbing maintenance systems of the present invention use the introduction of a combination of fluid and vacuum suction to a plumbing system to clean and maintain the piping thereof. The plumbing maintenance systems of the present invention may allow the internal diameter of the piping of the plumbing system to remain substantially similar to its original internal diameter.

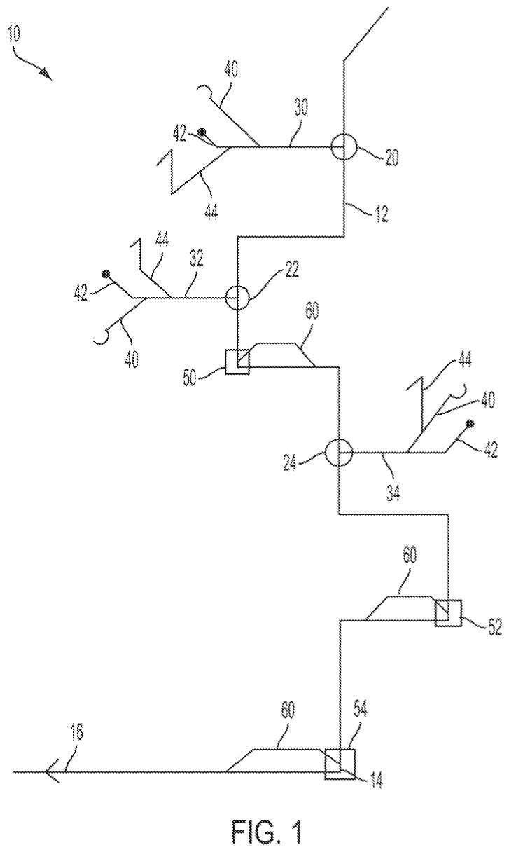

FIG. 1 illustrates a schematic of single stack or Sovent® system 10. As illustrated in FIG. 1, a Sovent system is a single stack drain system that uses one vertical pipe line 12 to both aerate and drain on multiple floors of a building. The vertical pipe line 12 is open to the atmosphere. At each floor an aerator fitting 20, 22, 24 may be connected in the vertical pipe line 12. Each aerator fitting may be connected to a respective horizontal pipe line 30, 32, 34 for connecting to a plumbing group comprising plumbing fixtures 40, 42, 44 on the respective floor, such as sinks, bath drains and the like. As shown in FIG. 1, the plumbing group may be a bathroom group comprising a tub or shower 40, a water closet or toilet 42 and a sink 44 may be connected to the horizontal pipe lines of the plumbing system 10. The horizontal pipe line of the plumbing system may also include more than one bathroom group or any other suitable combination of multiple plumbing groups on any single horizontal pipe line. Alternatively, in a single stack system for a kitchen grouping only a single fixture may be connected to each horizontal pipe line of the plumbing system or a plurality of kitchen groupings may be connected to each horizontal pipe line. In accordance with an embodiment of the present invention, the fixtures 40, 42, 44 may each define plumbing fixtures of the plumbing system. As illustrated in FIG. 1, the single stack plumbing system includes horizontal offsets comprising de-aerator fittings 50, 52, 54. As shown in FIG. 1, pressure relief vents 60 are provided at each de-aerator fitting. As shown in FIG. 1, the de-aerator fitting 54 is provided at the base 14 of the vertical pipe line 14 below the lowest aerator fitting 24. As shown in FIG. 1, the single stack drain system may exit 16 the building after the de-aerator fitting 54 at the base 14 of the vertical pipe line 12.

The plumbing maintenance system of the present invention may comprise a pump assembly and a vacuum assembly. The pump assembly may include a tank, a fluid conduit and a pumping device. The internal volume and dimensions of the tank may be varied depending on the fluid volume requirements for the plumbing maintenance system of the present invention. For example, the capacity of the tank may typically range from 1 to 100 gallons or more. In a particular embodiment the capacity of the tank may be about 50 gallons. The tank may be configured to contain any suitable fluid, such as water, a cleaning solution, and the like.

The fluid conduit of the pump assembly includes a first end and a second end. The first end may be configured for coupling to the tank of the pump assembly and the second end may be configured for coupling to the plumbing system. In examples, the first end may be configured to be removably coupled to the tank of the pump assembly, may be integrally formed with the tank of the pump assembly, or may be configured to be removably coupled to an intermediate connection piece in a fluidly sealed configuration.

The second end of the fluid conduit may be configured to be removably coupled to a plumbing fixture of the plumbing system in a fluidly sealed configuration. In an example, the second end of the fluid conduit may be configured to be removably coupled to an attachment piece that is sized and arranged to be coupled to the desired plumbing fixture. For example, the attachment piece may comprise any of a plurality of sizes and shapes on a first end to facilitate coupling with any of a variety of fixtures in a plumbing system, such as any of a plurality of sizes and shapes to couple with sink drains, shower drains, water closet fixture openings and the like. The connection of the attachment piece to the plumbing fixture may allow the tank of the pump assembly to be in fluid communication with the plumbing system. The fluid conduit may have an internal diameter selected to allow the fluid from tank of the pump assembly to be introduced into the plumbing assembly. For example, the internal diameter of the fluid conduit may be from 1 to 10 inches, or from 1.5 to 8 inches, or from 2 to 6 inches.

In examples, the fluid conduit may be coupled with sink drains, shower drains, water closet fixture openings, and the like. For example, the second end of the fluid conduit may have threads and may connect to a sink drain by removing a sink trap by removing a sink trap and connecting the second end of the fluid conduit to a drain pipe of the sink (such as by screwing the second end of the fluid conduit to the threads on an end of the drain pipe). For example, in the case of a toilet, the toilet and the wax ring may be removed and the second end of the fluid conduit may be connected through a fitting that connects to the floor flange. The second end of the fluid conduit may be connected to the fitting configured. In the case of a shower drain, the shower drain may be removed and the second end of the fluid conduit may be connected through a fitting that connects to the shower drain connector.

The pumping device may be a motor that allows fluid to be pumped from the tank. The pumping device may be selected in order to allow a volume of fluid stored in the tank to be introduced into the plumbing system in a variably determined period of time. For example, the pumping device may provide a flow rate of at least 20 gallons per minute, or at least 50 gallons per minute, or at least 75 gallons per minute, or at least 100 gallons per minute, or at least 120 gallons per minute. Alternatively, fluid may be introduced from the tank of the pump assembly into the plumbing system by a gravity feed.

The pump assembly may be a standard pump assembly known to those of skill in the art. The pump assembly may be an industrial pump assembly and optionally may be operated in accordance with technical specifications published by the manufacturer. For example, the pump assembly may have selected parameters known to those skilled in the art such as flow rate, vacuum level, operating pressure, pull down time, noise level and the like. In an example, the pump assembly may be a CONDE™ ProVac Industrial Pumpout Station. In an example, the pump assembly may be sized to pass through conventional doorways to allow the pump assembly to be positioned in the desired location of a building, e.g., in a residential unit or an office.

The vacuum assembly may include a vacuum conduit, a vacuum source and a vacuum tank. In accordance with an embodiment of the present invention, the vacuum conduit may have an internal diameter selected to allow sufficient suction to be created within the plumbing system to clear any build-up or debris formed or positioned within the pipes or fixtures of the plumbing system. For example, the internal diameter of the vacuum conduit may be from 1 to 16 inches, or from 1.5 to 14 inches, or from 2 to 10 inches. In accordance with an embodiment of the present invention, the vacuum conduit of the vacuum assembly includes a first end and a second end. The first end may be removably coupled to the vacuum source and the second end may be removably coupled to an opening of the plumbing system. Although the first end of the vacuum conduit may be removably coupled to the vacuum source, it is to be understood that any other suitable arrangement may be used, e.g., the vacuum conduit may be integrally formed with the vacuum source or may be coupled to a vacuum source connection piece. The vacuum conduit may be coupled to the vacuum source in a fluidly sealed configuration to prevent any air or fluid from leaking when the vacuum source is in suction mode while removing the debris.

The second end of the vacuum conduit may be removably coupled to an opening of the plumbing system in a fluidly sealed configuration. In an example, the vacuum conduit may be coupled to the plumbing system at an opening at the base of the vertical pipe line. For example, below the lowest de-aerator in a single stack system, there may be a coupling such as an elbow that feeds into the main sewer line. The coupling may be opened and the second end of the vacuum conduit may be connected to the coupling. By connecting to the coupling instead of a clean-out that may be present at the base of the vertical pipe line, the loss of vacuum pressure is reduced because the system is disconnected temporarily from the municipal sewer system whereas coupling to the clean-out would leave the vertical pipe line connected to the sewer system. In another example, the vacuum conduit may be coupled to the plumbing system at an opening below any de-aerator fitting positioned in the vertical pipe line. The vacuum conduit may be connected to the opening of the plumbing system by any suitable connection fixture that provides a fluidly sealed configuration between the vacuum conduit and the plumbing system. U.S. Pat. No. 10,301,804 issued May 28, 2019 and U.S. Patent Application Publication No. US2019/0270126A1 published Sep. 5, 2019, which are incorporated herein by reference, disclose a connection fixture which may be used to connect the vacuum conduit to the plumbing system, and methods for cleaning plumbing systems that may be used in combination with the system and methods of the present invention. For example, a first free opening of a y-shaped connection fixture may be connected to the opening of the plumbing system, a second free opening may be configured to receive a jetted water source and a third free opening may be configured to receive a video viewing device. The third free opening may be sealed during operation of the maintenance system or method and may be used to view the internal surfaces of the horizontal and/or vertical pipe lines via the video viewing device prior to or following operation of the systems or methods of the present invention.

The vacuum conduit may include a transparent surface portion positioned between an opening in the vacuum source and an opening in the plumbing system. The transparent surface portion may be removably attachable to a remaining portion of the vacuum conduit. Alternatively, the transparent surface portion may be integrally formed with the vacuum conduit. The transparent surface portion may be positioned closer to the opening in the vacuum source or closer to the opening of the plumbing system.

The vacuum source may be any suitable vacuum source that is capable of inducing a vacuum within the plumbing system. The amount of vacuum supplied by the vacuum source may be varied depending on the plumbing system. For example, the vacuum source may provide at least 250 CFM (cubic feet per minute) of suction power, or at least 500 CFM, or at least 750 CFM, or at least 1,000 CFM, or at least 1,500 CFM of suction power. In an example, the vacuum source may be an industrial strength hydrovac truck. Alternatively, the vacuum source may be a vacuum trailer or a standard vacuum or an industrial vacuum.

The vacuum tank may have capacity sufficient to retain at least the fluid introduced into the plumbing system by the pump assembly. The vacuum tank may have a volume to allow multiple horizontal pipe lines of the plumbing system to be cleaned according to the system and methods of the present invention without the need to empty the vacuum tank. For example, the vacuum tank may have a capacity of at least 50 gallons, or at least 100 gallons, or at least 240 gallons, or at least 500 gallons, or at least 1,000 gallons, or at least 1,500 gallons.

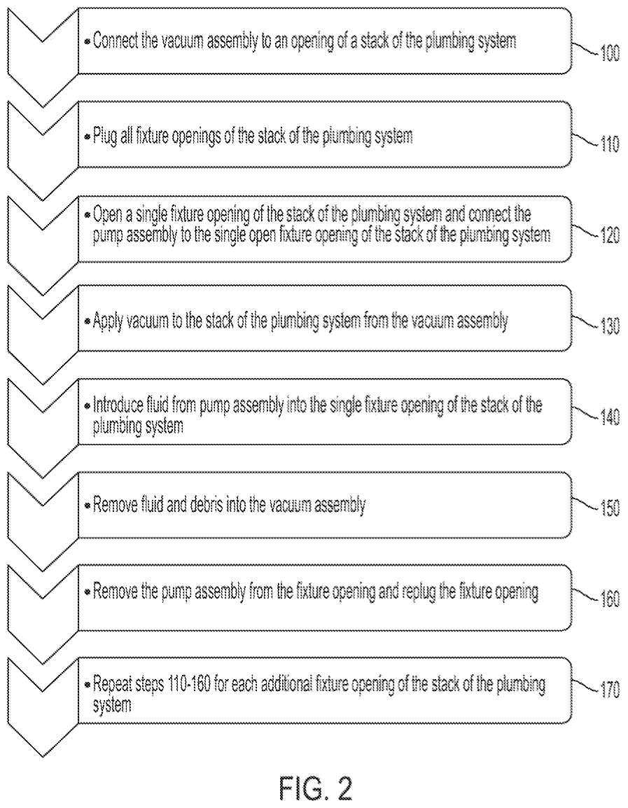

FIG. 2 is a flow diagram illustrating the steps of the method of maintaining a plumbing system in accordance with the present invention. In an example, the operation of the maintenance system or method may begin at the lowest horizontal pipe line connected to vertical pipe line 170 and may proceed up the vertical pipe line 170 sequentially to each horizontal pipe line connected to vertical pipe line 170. A method of maintaining a plumbing system may comprise connecting the vacuum assembly to an opening of the plumbing system 100. The vacuum source of the vacuum assembly may be connected to the plumbing system by the vacuum conduit. The opening of the plumbing system may be provided at the base of the vertical pipe line and/or below any de-aerator fitting of the vertical pipe line. Optionally, the connection to the plumbing system may be moved as the horizontal pipe line being cleaned moves up the vertical pipe line. Alternatively, the connection to the plumbing system may remain at the base of the vertical pipe line.

An opening of all but one of the plurality of plumbing fixtures on a horizontal pipe line may be sealed to result in a first unsealed plumbing fixture. As used herein, a “plumbing fixture” refers to a drain or a drain line for a receptacle such as a toilet, sink, shower, or tub, wherein the drain or drain line is connected to a horizontal pipe line. Each of the remaining plumbing fixtures of the plumbing system may be temporarily plugged or sealed 110 using any sealing or plugging device known to those of skill in the plumbing arts, such as, for example, an Expando® plug inserted into an end of a pipe or into a connector installed on a pipe, e.g., a Fernco® connector, or a blow-up plug inserted into a pipe opening, or the like. In other examples, a sink or a tub may be at least partially filled with water or another fluid and the drain sealed with a stopper or the like. Sealing the plumbing fixtures of all but one of the plumbing fixtures on the horizontal pipe line connected to the vertical pipe line prior to the maintenance of the plumbing system may prevent debris from exiting from such plumbing fixtures during the maintenance operations and allows for a stronger vacuum force to be applied to the vertical pipe line.

The fluid conduit of the pump assembly may be connected to the first unsealed plumbing fixture. Once the fluid conduit of the pump assembly is connected to the first unsealed plumbing fixture, the vacuum source of the vacuum assembly may be activated to apply vacuum suction to the plumbing system 130.

After the vacuum source is activated the pump assembly pumps fluid into the first unsealed plumbing fixture of the plumbing system. In an example, the pump assembly may pump at least 1 gallon of fluid into the plumbing system. In another example, the pump assembly may pump at least 2 gallons of fluid into the plumbing system, e.g., at least 5 gallons, or at least 10 gallons, or at least 25 gallons, or at least 50 gallons of fluid into the plumbing system. For example, the pump assembly may pump from 1 to 100 gallons, or from 20 to 75 gallons, or from 30 to 60 gallons of fluid into the plumbing system. The fluid may be pumped into the plumbing system at a high flow rate. For example, the fluid may be pumped into the plumbing system by the plumbing assembly at a flow rate of at least 1 gallon per minute, or at least 10 gallons per minute, or at least 20 gallons per minute, or at least 50 gallons per minute, or at least 75 gallons per minute, or at least 100 gallons per minute, or at least 120 gallons per minute. A high volume of fluid being introduced into the plumbing system in a short period of time results in turbulent flow along the horizontal and vertical pipe lines. The turbulent flow of fluid and vacuum suction may substantially remove the buildup of sludge and debris from the piping of the plumbing systems.

The fluid, sludge and debris may then be contained in the vacuum assembly 150. After the desired amount of fluid has been introduced into the plumbing fixture, the pump assembly is uncoupled from the plumbing fixture and the plumbing fixture is resealed 160. Following operation of the maintenance system or method on the first unsealed fixture, the first unsealed plumbing fixture may be sealed as described above and a second plumbing fixture on the horizontal pipe line is unsealed to form a second unsealed plumbing fixture and operation of the maintenance system or method is repeated. This sequential opening of a single plumbing fixture on the horizontal pipe line and the sealing of others may be repeated for all of the plumbing fixtures on the horizontal pipe line. The process may be repeated for each horizontal pipe line connected to a vertical pipe line 170. Alternatively, the maintenance process may be performed only for a single plumbing fixture of each horizontal pipe line or only two plumbing fixtures of each horizontal pipe line connected to vertical pipe line 170. In certain embodiments, the vacuum source is continually applied to plumbing system during the transfer of the pump assembly to each new plumbing fixture. Alternatively, the vacuum source may be turned off during the transfer of the pump assembly to each new plumbing fixture.

As used herein with respect to the positioning of the horizontal pipe lines along the vertical pipe line, “lowest” refers to the horizontal pipe line closest to ground level and “up” the vertical pipe line refers to a direction from the base of the vertical pipe line towards the roof of the building in which the plumbing system is installed. During the maintenance of horizontal pipe lines at higher elevations from the base of the vertical pipe line the vacuum suction may be too weak. As previously provided herein, the vacuum assembly may then be coupled to the plumbing system under any de-aerator at an elevated position of the vertical pipe line.

In accordance with an embodiment of the present invention, once the method of the present invention has been performed to all of the desired plumbing fixtures all of the plumbing fixtures are unsealed and water is flown through the plumbing system to confirm that the plumbing system is functioning properly.

Optionally, the method may further comprise installation of a temporary valve such as a manual ball valve connected to an end of the vertical pipe line 12 that is open to the atmosphere. The temporary valve may be manually adjusted to be at least partially closed in order to reduce air flow coming into the vertical pipe line 12 from the atmosphere, e.g., reduce air flow to zero, which may reduce vacuum loss through the end of the vertical pipe line.

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

For purposes of the description above, it is to be understood that the invention may assume various alternative variations and step sequences except where expressly specified to the contrary. Moreover, all numbers expressing, for example, quantities of ingredients used in the specification and claims, are to be understood as being modified in all instances by the term “about”. Accordingly, unless indicated to the contrary, the numerical parameters set forth are approximations that may vary depending upon the desired properties to be obtained by the present invention. At the very least, and not as an attempt to limit the application of the doctrine of equivalents, each numerical parameter should at least be construed in light of the number of reported significant digits and by applying ordinary rounding techniques.

It should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. hi addition, in this application, the use of “or” means “and/or” unless specifically stated otherwise, even though “and/or” may be explicitly used in certain instances. In this application, the articles “a,” “an,” and “the” include plural referents unless expressly and unequivocally limited to one referent.

In this application, the use of “horizontal” and “vertical” are used to indicate position relative to the upward position of the building. It is understood that a vertical pipe line may include some sections of pipe that are non-vertical in orientation, for example, to avoid obstacles in the building. It also is understood that a horizontal pipe may inherently require a certain degree of slope in order for fluid to flow through the plumbing system.

Whereas particular embodiments of this invention have been described above for purposes of illustration, it will be evident to those skilled in the art that numerous variations of the details of the present invention may be made without departing from the invention as defined in the appended claims.

We claim:

1. A method of maintaining fluid flow through a plumbing system for a multi-floor building comprising a substantially vertical pipe line having a base and a top and extending upwardly within the building and open to atmosphere at the top, at least one aerator connected to the vertical pipe line, at least one horizontal pipe line connected at a first end to the vertical pipe line and connected to a plurality of plumbing fixtures or to one of the aerators, and at least one de-aerator positioned at the base of the vertical pipe line, the method comprising:
sealing an opening of all but one of the plurality of plumbing fixtures to result in a first unsealed plumbing fixture;
connecting a vacuum assembly to an opening of the plumbing system below the horizontal pipe line by connecting a first end of a vacuum conduit to a vacuum source and a second end of the vacuum conduit to the opening of the plumbing system;
connecting a pump assembly to the unsealed plumbing fixture by connecting a first end of a fluid conduit to a tank and a second end of the fluid conduit to an opening of the first unsealed plumbing fixture;
activating the vacuum source to apply a vacuum suction to the plumbing system; and
introducing a volume of fluid from the pump assembly through the fluid conduit into the opening of the unsealed plumbing fixture;
wherein the activated vacuum source and the introduced volume of fluid achieve a flow rate that is greater than a gravity-fed pipe flow rate of the plumbing system.

2. The method of claim 1, wherein the fluid comprises water, a cleaning solution, or combinations thereof.

3. The method of claim 1, comprising introducing the volume of fluid from the pump assembly through the fluid conduit into the opening of the unsealed plumbing fixture at a rate of at least at least 20 gallons per minute.

4. The method of claim 1, wherein the vacuum conduit comprises a y-shaped connector.

5. The method of claim 1, further comprising installing a manual valve connected to the vertical pipe line open to the atmosphere.

6. The method of claim 5, further comprising adjusting the valve to control the flow of fluid through the plumbing system.

7. The method of claim 1, wherein the first unsealed plumbing fixture is positioned closer to the base of the vertical pipe line than to the top of the vertical pipe line.

8. The method of claim 1, following the introducing the volume of fluid, further comprising:
sealing the first unsealed plumbing fixture;
unsealing a second plumbing fixture;
connecting the pump assembly to the second unsealed plumbing fixture by connecting the first end of the fluid conduit to the tank and the second end of the fluid conduit to an opening of the second unsealed plumbing fixture;
activating the vacuum source to apply a vacuum suction to the plumbing system; and
introducing a volume of fluid from the pump assembly through the fluid conduit into the opening of the unsealed plumbing fixture.

9. The method of claim 8, wherein the second unsealed plumbing fixture is positioned between the top of the vertical pipe line and the first unsealed plumbing fixture.

10. A system for maintaining piping in a plumbing system, comprising:
a pump assembly comprising:
a tank, the tank structured and arranged to contain a volume of fluid therein; and
a fluid conduit having first and second ends, the fluid conduit structured and arranged to be fluidically connected at the first end to the tank and at the second end to a first plumbing fixture of the plumbing system;
a vacuum assembly comprising a vacuum source and a vacuum conduit, the vacuum conduit structured and arranged to be sealingly connected to a second opening of the plumbing system, wherein the vacuum assembly is configured to extract the fluid from the plumbing system;
wherein, in use, an activated vacuum source and an introduced volume of fluid achieve a flow rate that is greater than a gravity-fed pipe flow rate of the plumbing system.

11. The system of claim 10, wherein the plumbing system comprises a substantially vertical pipe line having a base and a top and extending upwardly within the building and open to atmosphere at the top, at least one aerator connected to the vertical pipe line, at least one horizontal pipe line connected at a first end to the vertical pipe line and connected to a plurality of plumbing fixtures or to one of the aerators, and at least one de-aerator positioned at the base of the vertical pipe line.

12. The system of claim 10, wherein the first end of the fluid conduit is configured to be removably coupled to the tank.

13. The system of claim 10, wherein the first end of the fluid conduit is integrally formed with the tank.

14. The system of claim 10, further comprising an intermediate connection configured for connection to the fluid conduit and configured for positioning between the fluid conduit and the tank.

15. The system of claim 10, further comprising a second intermediate connection configured for connection to the fluid conduit and configured for positioning between the fluid conduit and the plumbing system.

16. The system of claim 10, wherein the vacuum conduit is configured for coupling to the plumbing system at an opening at a base of a vertical pipeline.

17. The system of claim 10, wherein the vacuum conduit is configured for coupling to the plumbing system at an opening below a de-aerator in a vertical pipeline.

18. The system of claim 10, wherein the vacuum conduit comprises a y-shaped connector and/or a manual valve.
